(19) United States
(12) Patent Application Publication
(10) Pub. No.: US 2015/0359241 A1
(43) Pub. Date: Dec. 17, 2015

(54) AGENT FOR IMPARTING HYDROGENATED OIL FLAVOR

(71) Applicant: T. HASEGAWA CO., LTD., Tokyo (JP)

(72) Inventors: Koji OKUBO, Kanagawa (JP); Yui MASUDA, Kanagawa (JP); Yuko HAGIWARA, Kanagawa (JP)

(73) Assignee: T. HASEGAWA CO., LTD., Tokyo (JP)

(21) Appl. No.: 14/767,935

(22) PCT Filed: Mar. 18, 2014
(86) PCT No.: PCT/JP2014/057347

§ 371 Date: Aug. 14, 2015

(30) Foreign Application Priority Data
Apr. 10, 2013 (JP) 2013-082008

(51) Int. Cl. A23D 9/007; A23L 1/226

(52) U.S. Cl. CPC A23D 9/007; A23L 1/22628; A23L 1/22671; A23V 2002/00

(57) ABSTRACT

[Problem]

To provide an agent for imparting hydrogenated oil flavor that can impart a hydrogenated oil flavor leading to thick sweetness and rich taste to an oil product containing a reduced amount of hydrogenated oil.

[Means of Solution]

Provided is an agent for imparting hydrogenated oil flavor formed from (E)-6-octenal.

### TECHNICAL FIELD

The present invention relates to an agent for imparting hydrogenated oil flavor. More specifically, the present invention relates to an agent for imparting hydrogenated oil flavor formed from (E)-6-octenal, an agent composition for imparting hydrogenated oil flavor containing (E)-6-octenal as an active component, and an oil product containing the composition thereby having a hydrogenated oil flavor.

### BACKGROUND ART

Hydrogenated oil is widely used for oil food products such as margarine, shortening and butter cream; confectionery such as donuts, cakes, chocolates; and cooking oil for other food products. Due to properties such as relatively high melting point, heat resistance and oxidative stability of hydrogenated oil, it recently contributes to the improvement in the quality of food products cooked in microwave ovens by imparting crispy texture and freshly-fried crunchy texture to fried food products and the like.

Hydrogenated oil is an edible processed oil that is solid at normal temperature and manufactured by, for example, a method in which vegetable oil such as soybean oil, rapeseed oil, palm oil, coconut oil and palm kernel oil or animal oil such as whale oil, fish oil, beef tallow and lard is hydrogenated at a temperature of about 160 to about 180° C. in the presence of a nickel catalyst and the like. Hydrogenated oil is manufactured from inexpensive oil raw materials and has stable quality, and thus is used in large amounts in wide applications.

Many oils including sesame oil, soybean oil, rapeseed oil, lard and the like have a residual flavor of the raw material thereof. In this case, such oils are used for food production in order to exploit the flavor thereof. However, the distinct flavor from the raw material may hinder the flavor of some food products. Hydrogenated oil is configured to have unusual flavor/odour of the raw material, i.e., vegetable oil or animal oil, being removed, to have an aroma and flavor which is rather less distinctive and thus to be used in wide range of food products.

Hydrogenated oil has an odour referred to as “hydrogenation odour”, “hydrogenation return odour”, “return odour”, “hardening odour”, “hardening oil odour” and the like. The odour is caused by aldehydes and ketones typically including 6-nonenal, which are said to be generated from fatty acids in oil due to light, heat and the like (Non-Patent Documents 1 and 2).

The odour has been conventionally regarded as abnormal odour which may be unpopular. However, the odour recently tends to be recognised to impart to food products containing hydrogenated thick and mild sweetness which is built by processing the food products by heating and the like. For example, when donuts are deep-fried with oil containing hydrogenated oil, it has been seen that the cooked donuts have indescribable mild sweetness, so as to encourage customers to buy the products and impart sufficient satisfaction when the donuts are consumed. Products such as margarine and fat spreads containing hydrogenated oil were developed as butter substitutes. Unique rich taste and sweetness of such products enhances a milk flavor and is accepted and pervaded among general consumers over as long as several tens of years, and as a result is recognised as a favourable flavor.

Meanwhile it has been known that the hydrogenation process increases the amount of trans fatty acids in oil. Recently, the United States government has announced the guideline for labelling regarding trans fatty acids as trans fatty acids may cause arteriosclerosis. As a result, use of hydrogenated oil which contains a high amount of trans fatty acids is increasingly unpopular, and therefore there is a strong need for an efficient solution by, for example, developing an alternative oil.

Accordingly an oil product containing a reduced amount of trans fatty acids while having physical properties (such as a melting point) similar to hydrogenated oil has been developed, which is namely a hydrogenated oil substitute prepared by combining liquid fat and palm oil, lard, slightly hydrogenated oil, completely hydrogenated oil or the like followed by transesterification. However there has been a problem in that decreasing the degree of hydrogenation by such a method eliminates a unique flavor due to hydrogenation odour. Accordingly there is a strong need for development of a method that reduces the amount of trans fatty acids and imparts a hydrogenated oil flavor.

In the light of the problem, the following methods have been disclosed, for example: a method for reducing the amount of trans fatty acids while generating a flavor derived from hydrogenated oil by using 50% by mass or more of fractionated hard oil of palm oil (Patent Document 1); a method for providing cooling oil having a reduced amount of trans fatty acids and having a “hydrogenated oil flavor” similar to the flavor obtained by cooking conventional hydrogenated oil by using in combination palm oil and lard or a slightly hydrogenated oil instead of conventional hydrogenated oil (Patent Document 2); a method for reducing the amount of trans fatty acids while generating a flavor of hydrogenated oil by using palm oil purified by distillation (Patent Document 3); and a method for reducing the amount of trans fatty acids while generating a flavor derived from hydrogenated oil by using less than 50% of palm fractionated hard oil and 65% or less of palm fractionated soft oil (Patent Document 4). However, all the proposals disclosed in Patent Documents 1 to 4 contain a high amount of oil derived from palm oil and may decrease a flavor led by liquid oil odour resulting from linoleic acid and contain a high amount of hard fraction, thereby are insufficient in terms of quality and intensity of flavor.

There has been developed a manner for compensating for the flavor of hydrogenated oil of hydrogenated oil substitutes. For example, an agent for imparting hydrogenated oil flavor comprising vanillin and/or ethyl vanillin as an active component has been disclosed (Patent Document 5). However, the flavor is insufficient in terms of the quality and intensity thereof because the volatility is rather higher than the flavor of hydrogenated oil. It is also disclosed that using a partly hydrogenated oil having a peroxide value (POV) within a specific range can increase the hydrogenated oil flavor of low-trans fatty acid-containing oil (Patent Document 6). However, in order to obtain oil with high POV, a special treatment for increasing the peroxide value is required, which is time consuming. Further, it is disclosed that hydrogenated oil obtained from deodorised oil has a butter-like flavor (Patent Document 7). However, the oil is degraded due to the temperature during hydrogenation, contains highly volatile, unpleasant odour components and is insufficient in terms of the quality of the flavor.

### PRIOR ART DOCUMENT

### Patent Document

Patent Document 1: Japanese Patent Application Laid-open No. 2008-271818
Patent Document 2: Japanese Patent Application Laid-open No. 2009-5681
Patent Document 3: Japanese Patent Application Laid-open No. 2009-240220
Patent Document 4: Japanese Patent Application Laid-open No. 2010-99037
Patent Document 5: WO 2008/032852 Patent Document 6: Japanese Patent Application Laid-open No. 2009-89684
Patent Document 7: Japanese Translation of PCT Application No. 2010-504753

### Non-Patent Document

Non-Patent Document 1: “Shokuhin Yushi no Nioi no Seibun (Odour components of food oil)”, Journal of Japan Oil Chemist's Society, 17(1), 2-18 (1968)
Non-Patent Document 2: “Yushi no Nioi no Seibun ni tsuite (dai 2 ho) Suiten Shu no Kensaku (Odour components of oil (second report) Investigation of hydrogenation odour”, Journal of Japan Oil Chemist's Society, 19(9), 883-887 (1970)

### DISCLOSURE OF INVENTION

### Technical Problem

An object of the present invention is to provide an agent for imparting hydrogenated oil flavor that can impart a “hydrogenated oil flavor” similar to conventional hydrogenated oil to so-called normal hydrogenated oil substitutes, namely oil products containing a reduced amount of trans fatty acids while having physical properties (such as a melting point) similar to hydrogenated oil, namely hydrogenated oil substitutes prepared by combining non-hydrogenated oil and palm oil, lard, slightly hydrogenated oil, completely hydrogenated oil or the like.

### Solution to Problem

The inventors of the present invention carried out exhaustive studies in order to achieve the above object. As a result, the inventors now surprisingly found that oil can have a “hydrogenated oil flavor” by adding (E)-6-octenal to liquid oil at a certain concentration and that food products cooked with the oil can also have a favourable aroma and flavor referred to as a “hydrogenated oil flavor”. Thus the inventors have completed the present invention.

Accordingly the present invention provides the followings:

(1) An agent for imparting hydrogenated oil flavor formed from (E)-6-octenal;
(2) An agent composition for imparting hydrogenated oil flavor including (E)-6-octenal as an active component;
(3) An agent composition for imparting hydrogenated oil flavor including (E)-6-octenal and the following component A:

component A: one or more selected from the group consisting of 3-methyl-2,4-nonanedione, trans-4,5-epoxy-2(E)-decenal, (E)-6-nonenal, (Z)-6-nonenal, (Z)-6-octenal and (E)-2-nonenal;

(4) The agent composition for imparting hydrogenated oil flavor according to (2), including (E)-6-octenal at a concentration in the range of 10 ppb to 10 ppm;
(5) The agent composition for imparting hydrogenated oil flavor according to any of (2) to (4), wherein the composition includes (E)-6-octenal at 10 ppb to 10 ppm, and is added to an oil product having a hydrogenated oil content of less than 50% with regard to the total amount of oil, so that the amount of (E)-6-octenal in the oil product is in the range of 10 ppt to 10 ppb;
(6) The agent composition for imparting hydrogenated oil flavor according to (3), wherein the composition includes (E)-6-octenal and the component A, the content of (E)-6-octenal is 10 ppb to 10 ppm, and the ratio between (E)-6-octenal and the component A is in the range of ((E)-6-octenal)/3-methyl-2,4-nonanedione=0.01 to 10, ((E)-6-octenal)/(E)-6-nonenal=0.01 to 10, ((E)-6-octenal)/(Z)-6-nonenal=0.01 to 10, ((E)-6-octenal)/(Z)-6-octenal=0.01 to 10, ((E)-6-octenal)/(E)-2-nonenal=0.01 to 10 or ((E)-6-octenal)/trans-4,5-epoxy-2(E)-decenal=0.01 to 100;
(7) An oil product having a hydrogenated oil flavor, including the agent for imparting hydrogenated oil flavor according to (1) or the agent composition for imparting hydrogenated oil flavor according to any of (2) to (6), such that a concentration of (E)-6-octenal in the oil product is in the range of 10 ppt to 10 ppb;
(8) The oil product according to (7), wherein the hydrogenated oil content with regard to the total amount of oil is less than 50%;
(9) A flavor composition including (E)-6-octenal at 10 ppb to 10 ppm, the flavor composition being added to an oil product having a hydrogenated oil content of less than 50% with regard to the total amount of oil, so that the amount of (E)-6-octenal in the oil product is in the range of 10 ppt to 10 ppb;
(10) The flavor composition according to (9), wherein the composition includes (E)-6-octenal and the following component A, and the ratio between (E)-6-octenal and the component A is in the range of ((E)-6-octenal)/3-methyl-2,4-nonanedione=0.01 to 10, ((E)-6-octenal)/(E)-6-nonenal=0.01 to 10, ((E)-6-octenal)/(Z)-6-nonenal=0.01 to 10, ((E)-6-octenal)/(Z)-6-octenal=0.01 to 10, ((E)-6-octenal)/(E)-2-nonenal=0.01 to 10 or ((E)-6-octenal)/trans-4,5-epoxy-2(E)-decenal=0.01 to 100:

component A: one or more selected from the group consisting of 3-methyl-2,4-nonanedione, trans-4,5-epoxy-2(E)-decenal, (E)-6-nonenal, (Z)-6-nonenal, (Z)-6-octenal and (E)-2-nonenal;

(11) An oil product which is obtained by adding thereto the flavor composition according to (9) or (10), such that a concentration of (E)-6-octenal in the oil product is in the range of 10 ppt to 10 ppb, the oil product having a hydrogenated oil content of less than 50% with regard to the total amount of oil.

According to the present invention, margarine and fat spreads prepared by adding the agent for imparting hydrogenated oil flavor to oil can have a favourable aroma and flavor referred to as a “hydrogenated oil flavor”. In addition, food products cooked with oil containing the agent for imparting hydrogenated oil flavor of the present invention as cooking oil or heat-processed food products with the agent for imparting hydrogenated oil flavor of the present invention directly added thereto can also have a favourable aroma and flavor referred to as a “hydrogenated oil flavor”. As used herein, the term “hydrogenated oil flavor” means thick and mild sweetness which is built as a result of processing, e.g. heating, of food products containing hydrogenated oil, at least vegetable hydrogenated oil and particularly soybean hydrogenated oil.

An agent for imparting hydrogenated oil flavor and an oil product with a hydrogenated oil flavor imparted thereto of the present invention are hereinafter described in further detail.

An active component of the agent for imparting hydrogenated oil flavor of the present invention, (E)-6-octenal, is a well-known flavor compound, and is known to be added at 1 to 25 ppm to various food and beverage such as dairy products, oil food products, fruit processed products, vegetable processed products, confectionery, cereals, bakery products, meat products, seafood products, egg processed products, sweeteners, soup, alcohol beverages, non-alcohol beverages and the like (EFSA Journal 2011; 9(11); 2397, p. 22, p. 27, p. 44 (Table II. 1.1), p. 45 (Table II. 1.2). However, application and properties thereof as an agent for imparting hydrogenated oil flavor has not been known at all. Patent documents cited above do not disclose or suggest that (E)-6-octenal can impart to oil food products a hydrogenated oil flavor at a concentration of 10 ppt to 10 ppb which is far below the concentration in the food and beverage as described above (1 to 25 ppm).

Meanwhile (Z)-6-octenal, a geometric isomer of the compound of the present invention, is also a well-known flavor compound and is proposed to be used for cosmetic fragrance or cosmetic articles (U.S. Pat. Nos. 4,192,781 and 4,132,675). These U.S. patents disclose that (Z)-6-octenal has fat-like, soap-like, green-like and fruit-like aromas and can be used as a flavoring agent. It is also described that (Z)-6-octenal has green- and melon-like aromatic characteristics (J. Am. Oil Chem. Soc., 58(6), 680-682 (1981)) and that (Z)-6-octenal can be used as a milk flavor enhancing agent (Japanese Patent Application Laid-open No. 2003-189). However, these documents do not refer to (E)-6-octenal, which is a geometric isomer of (Z)-6-octenal, and do not disclose or suggest aromatic characteristics thereof.

An active component of the present invention, (E)-6-octenal, can also be obtained by separation by preparative chromatography from a mixture of geometric isomers of 6-octenal or can be obtained by synthesis according to the method described in, for example, J. Am. Chem. Soc., 86, 1964, 3759-3767.

The present invention relates to an agent for imparting hydrogenated oil flavor containing (E)-6-octenal as an active component. An active component of the present invention, (E)-6-octenal, can impart a hydrogenated oil flavor to an oil product such as margarine and fat spreads by adding to the oil product such as margarine and fat spreads at generally 10 ppt to 10 ppb, preferably 20 ppt to 5 ppb and more preferably 50 ppt to 2 ppb as (E)-6-octenal.

(E)-6-octenal is preferably added to the oil product as an agent composition for imparting hydrogenated oil flavor because the amount of (E)-6-octenal added to the oil product is extremely low in order to exhibit an effect as an agent for imparting hydrogenated oil flavor and the amount is within a specific range.

The agent composition for imparting hydrogenated oil flavor of the present invention can contain (E)-6-octenal at, on the basis of the mass of the imparting agent composition, generally 10 ppb to 10 ppm, preferably 20 ppb to 5 ppm and more preferably 50 ppb to 2 ppm. The agent composition for imparting hydrogenated oil flavor can be added at about 0.01% to 1% to an oil product, so that the amount of (E)-6-octenal in the oil product is 10 ppt to 10 ppb, preferably 20 ppt to 5 ppb and more preferably 50 ppt to 2 ppb, thereby the oil product is able to have thick and mild sweetness and rich taste closely similar to the “hydrogenated oil flavor” imparted thereto.

When the amount of (E)-6-octenal added to an oil product is less than 10 ppt, an effect for imparting a hydrogenated oil flavor is poor. When the amount of (E)-6-octenal added to an oil product is higher than 10 ppb, a characteristic aldehyde-like aroma intrinsic in (E)-6-octenal is distinctive, which is not preferable.

An oil product to which the agent for imparting hydrogenated oil flavor of the present invention is added is preferably the one containing less than 50% by mass of hydrogenated oil, particularly less than 30% by mass of hydrogenated oil and less than 20% by mass of hydrogenated oil. Thereby even when the amount of trans fatty acids contained is reduced, a “hydrogenated oil flavor” as a preferable aroma and flavor can be imparted to the oil product. An oil product containing more than 50% by mass of hydrogenated oil therein naturally has a hydrogenated oil flavor and thus use of the present agent is not required; however it has a disadvantage in that such an oil product contains a high amount of trans fatty acids.

Non-hydrogenated oil contained in an oil product of the present invention is not particularly limited and examples thereof include any edible oil such as soybean oil, rapeseed oil, safflower oil, corn oil, sunflower oil, cottonseed oil, rice oil, olive oil, palm oil, coconut oil, sesame oil, beef tallow, lard, fish oil and medium chain triglyceride and processed oil thereof obtained by fractionation, transesterification and the like. These oils may be respectively used alone or two or more oils may be used in combination. It is preferable that the raw material oil does not have aroma per se or it has been highly purified to such an extent that has almost no aroma.

Examples of hydrogenated oil contained in an oil product of the present invention include the one obtained by hydrogenating a raw material including vegetable oil such as soybean oil, rapeseed oil, palm oil, coconut oil and palm kernel oil or animal oil such as fish oil, beef tallow and lard, in the presence of a nickel catalyst and the like at a temperature of about 120 to about 200° C. The hydrogenated oil preferably has a melting point in the range of 10 to 40° C. and particularly 20 to 35° C. Examples of hydrogenated oil include rapeseed oil, soybean oil, sunflower seed oil, cottonseed oil, peanut oil, rice bran oil, corn oil, safflower oil, kapok oil, sesame oil, evening primrose oil and the like. These hydrogenated oils may be respectively used alone or two or more of them may be used in combination.

An oil product of the present invention is preferably selected so that it has a trans fatty acid content of 3% by mass or less. In nature, trans fatty acids are contained in milk fat at around 5% by mass and it is believed that consumption of trans fatty acids at such an extent may not significantly impact health. However, according to the present invention, hydrogenated oil-flavored oil having a “hydrogenated oil flavor” can be obtained while reducing the content of trans fatty acids which have health concerns, as described above.

The content of trans fatty acids in oil can be determined according to AOCS Official Method Ce 1f-96 (Revised 2002).

An oil product of the present invention may contain oil derived from palm as a part of non-hydrogenated oil. By using oil derived from palm, the oil product has an improved heat stability and can have a preferable “hydrogenated oil flavor” based on a plain palm oil flavor. The content of non-hydrogenated oil derived from palm is not strictly limited and may vary according to an application of hydrogenated oil-flavored oil within a broad range. Examples of the content include, however, on the basis of the mass of hydrogenated oil-flavored oil, generally at least 50% by mass, particularly at least 60% by mass and still particularly at least 80% by mass. Examples of the oil derived from palm include palm oil, palm olein and the like.

The agent composition for imparting hydrogenated oil flavor of the present invention may further contain, in addition to (E)-6-octenal, one or more flavors selected from the group consisting of 3-methyl-2,4-nonanedione, trans-4,5-epoxy-2(E)-decenal, (E)-6-nonenal, (Z)-6-nonenal, (Z)-6-octenal and (E)-2-nonenal. Thereby it is possible to impart to an oil product a further preferable hydrogenated oil flavor.

The ratio between (E)-6-octenal and the other flavor is, provided that one or more selected from the group consisting of 3-methyl-2,4-nonanedione, (E)-6-nonenal, (Z)-6-nonenal, (Z)-6-octenal and (E)-2-nonenal is designated as a component A, in the range of ((E)-6-octenal)/A=0.001 to 100 and preferably 0.01 to 10 on the mass basis, or alternatively ((E)-6-octenal)/trans-4,5-epoxy-2(E)-decenal=0.001 to 1000 and preferably 0.01 to 100.

The agent composition for imparting hydrogenated oil flavor of the present invention may optionally contain a conventional flavor compound which is used for dairy flavoring agents such as butter flavoring agents. Examples of the conventional flavor compound include, without limitation, acids such as formic acid, propionic acid, butyric acid, valeric acid, isovaleric acid, caproic acid, trans-2-hexenoic acid, heptanoic acid, caprylic acid, nonanoic acid, 5-hydroxynonanoic acid, capric acid, 2-decenoic acid, 4-decenoic acid, 5-decenoic acid, 6-decenoic acid, 9-decenoic acid, 5-hydroxydecenoic acid, 5-hydroxyundecanoic acid, lauric acid, 5-hydroxydodecanoic acid, myristic acid, pentadecanoic acid, isopentadecanoic acid, palmitic acid, heptadecanoic acid, stearic acid, oleic acid, linoleic acid and linolenic acid; aldehydes such as acetaldehyde, propanal, butanal, 2-butenal, hexanal, octanal, 4-heptenal, 2,4-octadienal, nonanal, 2-nonenal, 2,4-nonadienal, 2,6-nonadienal, decanal, 2,4-decadienal, undecanal, 2,4-undecadienal, dodecanal, benzaldehyde, vanillin, ethyl vanillin and furfural; esters such as ethyl formate, ethyl acetate, butyl acetate, isoamyl acetate, decyl acetate, dodecyl acetate, phenethyl acetate, ethyl lactate, ethyl butyrate, ethyl 2-methylbutyrate, ethyl 3-ethylbutyrate, methyl valerate, methyl caproate, ethyl caproate, methyl heptanoate, ethyl heptanoate, ethyl caprylate, isoamyl caprylate, heptyl caprylate, methyl nonanoate, ethyl nonanoate, methyl caprate, ethyl caprate, ethyl undecanoate, methyl laurate, ethyl laurate, ethyl myristate, ethyl palmitate, methyl salicylate, diethyl succinate, diethyl sebacate, ethyl 5-hydroxyhexanoate, ethyl 5-hydroxydecanoate, ethyl 5-hydroxyundecanoate, propyl 5-hydroxydecanoate, isopropyl 5-hydroxydecanoate, 2-methylpropyl 5-hydroxyoctanoate and ethyl 5-hydroxy-9-methyldecanoate; alcohols such as ethanol, propanol, butanol, pentanol, hexanol, heptanol, octanol, nonanol, decanol, benzyl alcohol, phenylethyl alcohol and furfuryl alcohol; ketones such as 2-heptanone, 2-octanone, 3-octanone, 1-octen-3-one, 2-nonanone, 3-nonanone, 8-nonen-2-one, 2-undecanone, 2-tridecanone, acetoin, 5-hydroxy-4-octanone, diacetyl, 2,3-pentadione, 2,3-hexadione, 2,3-heptadione, acetyl isovaleryl, p-methoxyacetophenone, benzophenone and maltol; oxygen-containing cyclic compounds such as 3-hydroxy-2-methyl-4H-pyran-4-one, 2-ethyl-3-hydroxy-4H-pyran-4-one, 2,5-dimethyl-4-hydroxy-3(21)-furanone, 3-methyl-1,2-cyclopentanedione, 3-ethyl-1,2-cyclopentanedione, 3,4-methylenedioxybenzaldehyde, 3-hydroxy-4,5-dimethyl-2(5H)-furanone, 5-ethyl-3-hydroxy-4-methyl-2(5H)-furanone, 2-ethyl-4-hydroxy-5-methyl-3(2H)-furanone and 3,4-dimethyl-1,2-cyclopentanedione; nitrogen-containing compounds such as phenylethyl anthranilate, trimethylamine, indole, skatole, pyridine, isoquinoline, pyrazine and methylpyrazine; sulphur-containing compounds such as methyl mercaptan, isobutyl mercaptan, 2,4-dithiapentane, dimethyl sulphide, dimethyl disulphide, 2,4-dithiapentane, dimethyl trisulphide, dimethyl sulphoxide, dimethyl sulphone, methanethiol, methylsulphonylmethane, methyl isothiocyanate, ethyl isothiocyanate, allyl isothiocyanate, 2-methyl-3-butanethiol, methional, ethyl thioacetate, methyl thiobutyrate, 3-butenyl isothiocyanate, 2-methylthiophene, benzothiazole, sulphurol, acetyl lactic acid thiomethyl ester, propionyl lactic acid thiomethyl ester, butyryl lactic acid thiomethyl ester, valeryl lactic acid thiomethyl ester, 2-methylbutyryl lactic acid thiomethyl ester, decylyl lactic acid thiomethyl ester, acetyl lactic acid thioethyl ester, propionyl lactic acid thioethyl ester, butyryl lactic acid thioethyl ester, valeryl lactic acid thioethyl ester, and isocaproyl lactic acid thiopropyl ester; lactones such as γ-caprolactone, heptalactone, γ-octalactone, nonalactone, rdecalactone, 7-decen-4-olide, 3-methyl-4-decen-4-olide, 3-methyl-5-decen-4-olide, rundecalactone, dodecalactone, γ-tridecalactone, γ-tetradecalactone, δ-caprolactone, 2-hexen-5-olide, 2-hepten-5-olide, δ-octalactone, 2-octen-5-olide, 4-methyl-5-octanolide, δ-nonalactone, 2-nonen-5-olide, 4-methyl-5-nonanolide, δ-decalactone, 2-decen-5-olide, 4-methyl-5-decanolide, δ-undecalactone, 2-undecen-5-olide, 4-methyl-5-undecanolide, δ-dodecalactone, 2-dodecen-5-olide, 4-methyl-5-dodecanolide, δ-tridecalactone, 2-tridecen-5-olide, 4-methyl-5-tridecanolide, δ-tetradecalactone, 2-tetradecen-5-olide, 2-pentadecen-5-olide, 2-hexadecen-5-olide, 2-heptadecen-5-olide, 2-octadecen-5-olide, 2-nonadecen-5-olide, 2-eicosen-5-olide and ε-decalactone.

The agent composition for imparting hydrogenated oil flavor of the present invention may include the flavor compound at, on the basis of the mass of the agent composition for imparting hydrogenated oil flavor of the present invention, generally 0.001 to 50% by mass, preferably 0.1 to 15% by mass and more preferably 1 to 5% by mass.

The agent composition for imparting hydrogenated oil flavor of the present invention may include the fatty acid at, on the basis of the mass of the imparting agent composition, generally 0.1 to 95% by mass, preferably 1 to 60% by mass and more preferably 5 to 30% by mass.

The agent composition for imparting hydrogenated oil flavor of the present invention may further include, as appropriate, a solvent component such as MCT (medium chain triglyceride) and glyceride; an antioxidant such as vitamin E; an oil-soluble component compatible with food products such as a flavor and a spice extract.

The agent for imparting hydrogenated oil flavor or the agent composition for imparting hydrogenated oil flavor of the present invention described hereinabove may be directly added to food products, for example, donuts, bread or premixes thereof; confectionery such as cakes, pies and chocolates and the like followed by processing by heating, thereby imparting a hydrogenated oil flavor to the food products, or alternatively may be added to oil to prepare hydrogenated oil flavored oil.

Examples of the raw material oil to which the agent for imparting hydrogenated oil flavor of the present invention is added to prepare hydrogenated oil flavored oil include any edible oil such as soybean oil, rapeseed oil, safflower oil, corn oil, sunflower oil, cottonseed oil, rice oil, olive oil, palm oil, coconut oil, sesame oil, beef tallow, lard, fish oil, hydrogenated oil and MCT and processed oil thereof obtained by fractionation, hydrogenation and transesterification. These oils may be respectively used alone or two or more oils may be used in combination. It is preferable that the raw material oil does not have aroma per se or it has been highly purified to such an extent that it has almost no aroma.

The raw material oil which is used for the hydrogenated oil flavored oil of the present invention may contain hydrogenated oil as a part thereof. It is preferable that the raw material oil contains 1 to 20% by mass, particularly 2 to 10% by mass of hydrogenated oil and 80 to 99% by mass, particularly 90 to 98% by mass of non-hydrogenated oil. Thereby even when the content of trans fatty acids is reduced, the oil may have a hydrogenated oil flavor as a favourable aroma and flavor. By employing such an amount of addition, the hydrogenated oil flavored oil may have a trans fatty acid content of 3% by mass or less and also have a favourable hydrogenated oil flavor. In nature, trans fatty acids are contained, for example, in milk fat at around 5% by mass and it is believed that consumption of trans fatty acids at such an extent may not significantly impact health. When the hydrogenated oil flavored oil contains an extremely high amount of hydrogenated oil, unpleasant hydrogenation odour may be detected when the oil is used for cooking, and when the amount is extremely low, a preferable hydrogenated oil flavor may not be sufficiently imparted.

Examples of the hydrogenated oil used in this case include oil obtained by, for example, a method in which a raw material such as vegetable oil including soybean oil, rapeseed oil, palm oil, coconut oil and palm kernel oil or animal oil including fish oil, beef tallow and lard is hydrogenated at a temperature of about 120 to about 200° C. in the presence of a nickel catalyst and the like.

The raw material oil used for the hydrogenated oil flavored oil of the present invention may contain oil derived from palm as a part thereof. Examples of the oil derived from palm include palm oil, palm olein and the like. Particularly it is preferred to use a hydrogenated oil flavored oil containing palm oil for fat spreads, because the fat spreads may have appropriate consistency to be spread on appropriate bread.

The hydrogenated oil flavored oil of the present invention may further optionally contain an additive such as an emulsifying agent, an antioxidant, an antifoam and a colorant.

The agent for imparting hydrogenated oil flavor, the agent composition for imparting hydrogenated oil flavor or the hydrogenated oil flavored oil of the present invention may be used to prepare spreads, margarine and the like, thereby imparting a hydrogenated oil flavor leading to rich taste and thick and mild sweetness and creamy texture of milk to the spreads and margarine. The agent for imparting hydrogenated oil flavor, the agent composition for imparting hydrogenated oil flavor or the hydrogenated oil flavored oil of the present invention may also be widely, used for food products containing oil other than spreads and margarine, resulting in the similar effect. Examples of the food and beverages containing oil include, without limitation, beverages such as milk, soya milk, milk-based drink, coffee drink containing milk, black tea drink containing milk, lactic acid drink and cocoa; dessert such as yogurt, jelly, pudding and mousse; cream such as butter cream and whipped cream; confectionery such as western and Japanese baked and steamed confectionery including various cakes, steamed buns with fillings; frozen dessert such as ice cream; chocolates such as milk chocolates; sweets such as chewing gum, hard candies, nougat candies and jelly beans; breads such as sweet buns; condiments such as miso, soy sauce, broth, dressings, mayonnaise, amino acid condiments, nucleic acid condiments, acidic flavor condiments, fermented condiments, pork extract, chicken extract, fish extract, yeast extract, protein hydrolysate, fish sauce, chilli bean paste, dried fish, konbu broth, soup stock, Chinese soup stock, sauce for barbequed meat, curry stock, stew stock, soup stock, broth stock, combined condiments, soup for noodle dishes (soba, udon, ramen, pasta and the like); sauces such as sauce for barbecued meat, barbecued chicken on skewers, broiled eel and the like and ketchup; soup such as corn soup, clear soup, egg soup, thick soup and miso soup; processed livestock products such as ham, sausages, cheese; seafood paste products such as tube-shaped fish cakes (chikuwa), seafood sticks (kani-kama) and boiled fish paste (kamaboko); retort food; snacks such as crisps, crackers, rice crackers and cookies; food boiled in soy sauce, prepared everyday dishes, frozen food, braised food, fried food, grilled food and the like.

The present invention is more specifically described hereinafter by way of Examples.

### EXAMPLES

### Reference Example 1

### Preparation of a Margarine Composition Mainly Containing Hydrogenated Oil

Hydrogenated soybean oil (melting point: 34° C.; 603 g) and 200 g of soybean oil were mixed. To the oil heated to 70° C., 1 g of soya lecithin and 1 g of sorbitan monostearate were added and mixed to prepare an oil phase. Separately, 180 g of water, 20 g of powdered skimmed milk and 3 g of sugar ester were mixed and then thoroughly solubilised at 70° C. to prepare an aqueous phase. The oil phase and the aqueous phase were emulsified on a high-pressure homogenizer and cooled and solidified to prepare a margarine composition (reference product 1) having a content of hydrogenated oil in the oil of 75.1%.

### Reference Example 2

### Preparation of a Margarine Composition Containing a Reduced Amount of Hydrogenated Oil (20% or Less in Oil)

Hydrogenated soybean oil (melting point: 34° C.; 160 g), 393 g of palm oil (melting point: 42° C.) and 250 g of soybean oil were mixed. To the oil heated to 70° C., 1 g of soya lecithin and 1 g of sorbitan monostearate were added and mixed to prepare an oil phase. Separately, 180 g of water, 20 g of powdered skimmed milk and 3 g of sugar ester were mixed and then thoroughly solubilised at 70° C. to prepare an aqueous phase. The oil phase and the aqueous phase were emulsified on a high-pressure homogenizer and cooled and solidified to prepare a margarine composition (reference product 2) having a content of hydrogenated oil in the oil of 19.9%.

### Example 1

### Preparation of Margarine Compositions Containing (E)-6-Octenal

Margarine compositions, namely present products 1 to 4 and comparative products 1 to 4, were prepared by adding (E)-6-octenal (appropriately diluted with soybean oil) to the oil phase in the preparation of the oil phase described in Reference Example 2, so as to obtain the concentrations of (E)-6-octenal in the margarine compositions as indicated in Table 1.

### (Sensory Evaluation)

Margarine compositions containing (E)-6-octenal of present products 1 to 4 and comparative products 1 to 4 and margarine compositions of reference product 1 and reference product 2 were subjected to sensory evaluation for the flavor thereof by 10 well-trained evaluators. Evaluation was carried out according to the following evaluation criteria and total scores are shown in Table 1. A summary of average sensory evaluation by all evaluators is also shown in Table 1.

### Evaluation Criteria

Has thick and mild sweetness and rich taste as intense as those of the product (reference product 1) mainly containing hydrogenated oil: 3 points

Has thick and mild sweetness and rich taste slightly lower than those of the product (reference product 1) mainly containing hydrogenated oil: 2 points

Has no thick and mild sweetness or rich taste: 1 point

TABLE 1
Sensory evaluation of margarine compositions

| | Hydrogenated | | | | |
|---|---|---|---|---|---|
| | oil content in | Concentration | | | |
| | oil in | of | | | |
| | margarine | (E)-6-octenal | | Total | |
| | composition | added | | score | Sensory evaluation |
| Reference | 75.1% | — | | (30) | Has thick sweetness and rich taste while also having |
| product 1 | | | | | unpleasant hydrogenation odour. |
| Reference | 19.9% | — | | 10 | Has no thick sweetness and has aroma derived from |
| product 2 | | | | | vegetable oil. |
| Comparative | 19.9% | 1 | ppt | 10 | Has no difference from Reference product 2. |
| product 1 | | | | | |
| Comparative | 19.9% | 3 | ppt | 14 | Has almost no difference from reference product 2. |
| product 2 | | | | | |
| Present | 19.9% | 10 | ppt | 21 | Has thick sweetness and rich taste, which are slightly |
| product 1 | | | | | unbalanced. |
| Present | 19.9% | 100 | ppt | 22 | Has thick sweetness and rich taste, which are slightly |
| product 2 | | | | | unbalanced. |
| Present | 19.9% | 1 | ppb | 24 | Has sufficient thick sweetness and rich taste. |
| product 3 | | | | | |
| Present | 19.9% | 10 | ppb | 26 | Has sufficient thick sweetness and rich taste. |
| product 4 | | | | | |
| Comparative | 19.9% | 30 | ppb | 26 | Has sufficient thick sweetness and rich taste, while having |
| product 3 | | | | | an odd, sharp and distinctive aroma of aldehyde. |
| Comparative | 19.9% | 100 | ppb | 25 | Has sufficient thick sweetness and rich taste, while having |
| product 4 | | | | | an odd, sharp and distinctive aroma of aldehyde. |

As shown in Table 1, the margarine composition of reference product 1 containing 75.1% of hydrogenated oil in the oil gave a result where thick and mild sweetness and rich taste were exhibited while exhibiting unpleasant hydrogenation odour as well. Meanwhile, the margarine composition of reference product 2 containing 19.9% of hydrogenated oil in the oil did not have thick sweetness but had an aroma derived from vegetable oil. In contrast, margarine compositions (the amount of hydrogenated oil used in the oil: 19.9%) containing the present products 1 to 4 which are flavor compositions obtained by adding (E)-6-octenal to reference product 2 respectively had thick and mild sweetness and rich taste imparted thereto which are of hydrogenated oil and did not have unpleasant hydrogenation odour. The results showed that when the concentration of (E)-6-octenal added to a margarine composition was in the range of 10 ppt to 10 ppb, the margarine composition had thick sweetness and rich taste imparted thereto and had a flavor which was not particularly odd. On the other hand, the results showed that when the concentration of (E)-6-octenal added to a margarine composition was less than 10 ppt, the margarine composition did not have thick sweetness or rich taste imparted thereto and when the concentration of (E)-6-octenal added to a margarine composition was higher than 10 ppb, the margarine composition had thick sweetness and rich taste while having an odd, sharp and distinctive aroma of aldehyde.

### Reference Example 3

### Preparation of a Butter Flavor Base Composition

According to the formulation shown in Table 2, a butter flavor base composition (reference product 3) was prepared.

TABLE 2
Formulation of butter flavor base composition
(reference product 3)

| Components | Amount added |
|---|---|
| Butyric acid | 60 |
| Valeric acid | 4 |
| Isovaleric acid | 2 |
| Caproic acid | 12 |
| Caprylic acid | 18 |
| Nonanoic acid | 1 |
| Ethyl butyrate | 2 |
| γ-Decalactone | 5 |
| δ-Decalactone | 1 |
| Diacetyl | 50 |
| MCT (solvent) | 845 |
| Total | 1000 |

### Reference Example 4

### Preparation of a Margarine Composition Mainly Containing Hydrogenated Oil

Hydrogenated soybean oil (melting point: 34° C.; 603 and 200 g of soybean oil were mixed. To the oil heated to 70° C., 1 g of soya lecithin and 1 g of sorbitan monostearate were added and mixed to prepare an oil phase. Separately, 180 g of water, 20 g of powdered skimmed milk and 3 g of sugar ester were mixed and then thoroughly solubilised at 70° C. to prepare an aqueous phase. The oil phase, the aqueous phase and 1 g of the butter flavor base composition (reference product 3) shown in Table 2 were then emulsified on a high-pressure homogenizer and cooled and solidified to prepare a margarine composition (reference product 4) having a content of hydrogenated oil in the oil of 75.1%.

### Reference Example 5

### Preparation of a Margarine Composition Containing a Reduced Amount of Hydrogenated Oil (20% or Less in Oil)

Hydrogenated soybean oil (melting point: 34° C.; 160 g), 393 g of palm oil (melting point: 42° C.) and 250 g of soybean oil were mixed. To the oil heated to 70° C., 1 g of soya lecithin and 1 g of sorbitan monostearate were added and mixed to prepare an oil phase. Separately, 180 g of water, 20 g of powdered skimmed milk and 3 g of sugar ester were mixed and then thoroughly solubilised at 70° C. to prepare an aqueous phase. The oil phase, the aqueous phase and 1 g of the butter flavor base composition (reference product 3) shown in Table 2 were then emulsified on a high-pressure homogenizer and cooled and solidified to prepare a margarine composition (reference product 5) having a content of hydrogenated oil in the oil of 19.9%.

### Example 2

### Preparation of Margarine Compositions Containing (E)-6-Octenal

Butter flavor compositions (designated as present products 5 to 8 and comparative products 5 to 8, respectively) were prepared by adding (E)-6-octenal at the amounts (concentrations) indicated in Table 3 to the butter flavor base composition of Reference Example 3, and then margarine compositions were prepared by using the respective butter flavor compositions instead of the butter flavor base composition (reference product 3) used in Reference Example 5.

TABLE 3

| | Concentration of (E)-6-octenal added | |
|---|---|---|
| | to butter flavor base composition | |
| | (reference product 3) | |
| Comparative product 5 | 1 | ppb |
| Comparative product 6 | 3 | ppb |
| Present product 5 | 10 | ppb |
| Present product 6 | 100 | ppb |
| Present product 7 | 1 | ppm |
| Present product 8 | 10 | ppm |
| Comparative product 7 | 30 | ppm |
| Comparative product 8 | 100 | ppm |

(Sensory Evaluation)

Margarine compositions containing butter-like flavor compositions of present products 5 to 8 and comparative products 5 to 8 and margarine compositions of reference product 4 and reference product 5 were subjected to sensory evaluation for the flavor thereof by 10 well-trained evaluators. Evaluation was carried out according to the following evaluation criteria and total scores are shown in Table 4. A summary of average sensory evaluation by all evaluators is also shown in Table 4.

### Evaluation Criteria

Has thick and mild sweetness and rich taste of hydrogenated oil as intense as those of the margarine (reference product 4) mainly containing hydrogenated oil: 5 points

Has thick and mild sweetness and rich taste of hydrogenated oil slightly lower than those of the margarine (reference product 4) mainly containing hydrogenated oil: 4 points

Has thick and mild sweetness and rich taste of hydrogenated oil moderately lower than those of the margarine (reference product 4) mainly containing hydrogenated oil: 3 points

Has thick and mild sweetness and rich taste of hydrogenated oil significantly lower than those of the margarine (reference product 4) mainly containing hydrogenated oil: 2 points

Has almost no thick and mild sweetness and rich taste of hydrogenated oil: 1 point

TABLE 4
Sensory evaluation of margarine compositions

| | Hydrogenated | | | | |
|---|---|---|---|---|---|
| | oil content in | | | | |
| | oil in | Concentration | | | |
| | margarine | of (E)-6-octenal | | Total | |
| | composition | added | | score | Sensory evaluation |
| Reference product 4 | 75.1% | — | | (50) | Has a light butter-like aroma, thick and mild sweetness |
| | | | | | and rich taste of hydrogenated oil, while also having |
| | | | | | unpleasant hydrogenation odour. |
| Reference product 5 | 19.9% | — | | 10 | Has a light butter-like aroma without thick sweetness |
| | | | | | and has an aroma derived from vegetable oil. |
| Product containing | 19.9% | 1 | ppt | 14 | No significant difference from reference product 5. |
| comparative product 5 | | | | | |
| Product containing | 19.9% | 3 | ppt | 19 | Has a light butter-like aroma, although has thick and |
| comparative product 6 | | | | | mild sweetness and rich taste of hydrogenated oil that are |
| | | | | | significantly lower than those of reference product 4. |
| Product containing | 19.9% | 10 | ppt | 31 | Has a light butter-like aroma and a flavor of |
| present product 5 | | | | | hydrogenated oil, although having thick and mild |
| | | | | | sweetness and rich taste of hydrogenated oil that are |
| | | | | | moderately lower than those of reference product 4. |
| Product containing | 19.9% | 100 | ppt | 35 | Has a light butter-like aroma and a flavor of |
| present product 6 | | | | | hydrogenated oil, although having thick and mild |
| | | | | | sweetness and rich taste of hydrogenated oil that are |
| | | | | | moderately lower than those of reference product 4. |
| Product containing | 19.9% | 1 | ppb | 44 | Has a light butter-like aroma as well as thick and mild |
| present product 7 | | | | | sweetness and rich taste of hydrogenated oil at a similar |
| | | | | | extent as reference product 4. |
| Product containing | 19.9% | 10 | ppb | 46 | Has a light butter-like aroma as well as thick and mild |
| present product 8 | | | | | sweetness and rich taste of hydrogenated oil at a similar |
| | | | | | extent as reference product 4. |
| Product containing | 19.9% | 30 | ppb | 45 | Has a light butter-like aroma as well as thick and mild |
| comparative product 7 | | | | | sweetness and rich taste of hydrogenated oil at a similar |
| | | | | | extent as reference product 4, although also having an |
| | | | | | odd, sharp and distinctive aroma of aldehyde. |
| Product containing | 19.9% | 100 | ppb | 48 | Has a light butter-like aroma as well as thick and mild |
| comparative product 8 | | | | | sweetness and rich taste of hydrogenated oil at a similar |
| | | | | | extent as reference product 4, although also having an |
| | | | | | odd, sharp and distinctive aroma of aldehyde. |

As shown in Table 4, the result showed that the margarine composition of reference product 4 containing 75.1% of hydrogenated oil in the oil and also containing the butter flavor base composition had a light butter-like aroma as well as thick and mild sweetness and rich taste of hydrogenated oil while also having unpleasant hydrogenation odour. Meanwhile, the margarine composition of reference product 5 containing 19.9% of hydrogenated oil in the oil and also containing the butter flavor base composition had a light butter-like aroma without thick sweetness and had an aroma derived from vegetable oil. In contrast, margarine compositions (the amount of hydrogenated oil used in the oil: 19.9%) containing the present products 5 to 8 which are flavor compositions obtained by adding (E)-6-octenal to the flavor composition of reference product 3 respectively had a light butter-like aroma as well as thick and mild sweetness and rich taste imparted thereto which are of hydrogenated oil and did not have unpleasant hydrogenation odour. The results showed that when the concentration of (E)-6-octenal added was in the range of 10 ppb to 10 ppm in the flavor composition (the concentration in the margarine composition of 10 ppt to 10 ppb), the margarine composition had a light butter-like aroma, a hydrogenated oil flavor that can impart thick and mild sweetness and rich taste of hydrogenated oil, and a flavor which was not particularly odd. On the other hand, the results showed that when the concentration of (E)-6-octenal added was less than 10 ppb in the flavor composition (the concentration in the margarine composition of less than 10 ppt), the margarine composition did not have thick and mild sweetness or rich taste of hydrogenated oil imparted thereto, and when the concentration of (E)-6-octenal added was higher than 10 ppm in the flavor composition (the concentration in the margarine composition of higher than 10 ppb), the margarine composition had thick and mild sweetness and rich taste of hydrogenated oil while having an odd, sharp and distinctive aroma of aldehyde.

### Example 3

Butter-like flavor compositions were prepared by adding, to 1 part by mass of the butter-like flavorbase composition of reference product 3, (E)-6-nonenal and 3-methyl-2,4-nonanedione, trans-4,5-epoxy-2(E)-decenal, (E)-6-nonenal, (Z)-6-nonenal, (Z)-6-octenal or (E)-2-nonenal at the concentrations indicated in Table 5.

TABLE 5

| | | Present | Present | Present | Present | Present | Present |
|---|---|---|---|---|---|---|---|
| | Present | product | product | product | product | product | product |
| | product 9 | 10 | 11 | 12 | 13 | 14 | 15 |
| (E)-6-Octenal | 200 ppb | 200 ppb | 200 ppb | 200 ppb | 200 ppb | 200 ppb | 200 ppb |
| 3-Methyl-2,4- | — | 2 ppm | — | — | — | — | — |
| nonanedione | | | | | | | |
| Trans-4,5-epoxy- | — | — | 2 ppm | — | — | — | — |
| 2(E)-decenal | | | | | | | |
| (E)-6-Nonenal | — | — | — | 2 ppm | — | — | — |
| (Z)-6-Nonenal | — | — | — | — | 2 ppm | — | — |
| (Z)-6-Octenal | — | — | — | — | — | 2 ppm | — |
| (E)-2-Nonenal | — | — | — | — | — | — | 2 ppm |

(Sensory Evaluation)

Margarine compositions (reference product 5 except that the flavor part was replaced) were prepared by adding 1 g (about 0.1%) of the butter-like flavor composition of each of present products 9 to 15 to the butter flavor base composition instead of the butter flavor base composition of Reference Example 3 (reference product 3). The margarine compositions were subjected to sensory evaluation for the flavor thereof by 10 well-trained evaluators using the reference product 4 (containing 75.1% of hydrogenated oil in the oil) as a control. Evaluation was carried out according to the same evaluation criteria as Example 2. Total scores and a summary of average sensory evaluation by all evaluators are shown in Table 6.

TABLE 6
Sensory evaluation of margarine compositions

| | Total score | Component A added | Sensory evaluation |
|---|---|---|---|
| Reference product 4 | (50) | — | Has a light butter-like aroma, thick and mild sweetness |
| (mainly containing | | | and rich taste of hydrogenated oil, while also having |
| hydrogenated oil) | | | unpleasant hydrogenation odour. |
| Reference product 5 | 10 | — | Has a light butter-like aroma without thick sweetness |
| (product containing | | | and has an aroma derived from vegetable oil. |
| reference product 3) | | | |
| Product containing | 38 | — | Has a light butter-like aroma and a hydrogenated oil |
| present product 9 | | | flavor, although having thick and mild sweetness and |
| | | | rich taste of hydrogenated oil that are moderately lower |
| | | | than those of reference product 4. |
| Product containing | 48 | 3-Methyl-2,4-nonanedione | Has a light butter-like aroma as well as thick and mild |
| present product 10 | | | sweetness and rich taste of hydrogenated oil at a similar |
| | | | extent as reference product 4 without hydrogenation |
| | | | odour, resulting in a favourable flavor. |
| Product containing | 45 | Trans-4,5-epoxy-2(E)-decenal | Has a light butter-like aroma as well as thick and mild |
| present product 11 | | | sweetness and rich taste of hydrogenated oil at a similar |
| | | | extent as reference product 4 without hydrogenation |
| | | | odour, resulting in a favourable flavor. |
| Product containing | 47 | (E)-6-Nonenal | Has a light butter-like aroma as well as thick and mild |
| present product 12 | | | sweetness and rich taste of hydrogenated oil at a similar |
| | | | extent as reference product 4 without hydrogenation |
| | | | odour, resulting in a favourable flavor. |
| Product containing | 45 | (Z)-6-Nonenal | Has a light butter-like aroma as well as thick and mild |
| present product 13 | | | sweetness and rich taste of hydrogenated oil at a similar |
| | | | extent as reference product 4 without hydrogenation |
| | | | odour, resulting in a favourable flavor. |
| Product containing | 48 | (Z)-6-Octenal | Has a light butter-like aroma as well as thick and mild |
| present product 14 | | | sweetness and rich taste of hydrogenated oil at a similar |
| | | | extent as reference product 4 without hydrogenation |
| | | | odour, resulting in a favourable flavor. |
| Product containing | 45 | (E)-2-Nonenal | Has a light butter-like aroma as well as thick and mild |
| present product 15 | | | sweetness and rich taste of hydrogenated oil at a similar |
| | | | extent as reference product 4 without hydrogenation |
| | | | odour, resulting in a favourable flavor. |

As shown in Table 6, the margarine-like composition containing present product 9 obtained by adding (E)-6-nonenal to the butter-like flavor composition of reference product 3 had a hydrogenated oil flavor while having thick and mild sweetness and rich taste of hydrogenated oil that were moderately lower than those of reference product 4 (a margarine composition mainly containing hydrogenated oil). Meanwhile margarine-like compositions containing butter-like flavor compositions (present products 10 to 15) respectively containing 3-methyl-2,4-nonanedione, trans-4,5-epoxy-2(E)-decenal, (E)-6-nonenal, (Z)-6-nonenal, (Z)-6-octenal or (E)-2-nonenal had thick and mild sweetness and rich taste of hydrogenated oil at a similar extent as reference product 4 without hydrogenation odour, resulting in a favourable flavor.

1-11. (canceled)

12. A method for imparting hydrogenated oil flavor to an edible fat or oil product which comprises adding to an edible fat or oil product (E)-6-octenal in an amount effective to impart hydrogenated oil flavor to the same.

13. The method of claim 12 which further comprises adding one or more flavorings which are selected from the group consisting of 3-methyl-2,4-nonanedione, trans-4,5-epoxy-2(E)-decenal, (E)-6-nonenal, (Z)-6-nonenal, (Z)-6-octenal and (E)-2-nonenal.

14. The method of claim 12 by which an edible fat or oil product is made to contain (E)-6-octenal at a concentration in the range of 10 ppt to 10 ppb by mass.

15. The method of claim 12 which the edible fat or oil product contains less than 50% by mass of hydrogenated oil on the basis of the total mass of fat or oil which is contained in the edible fat or oil product.

16. The method of claim 12 which further comprises adding one or more flavorings selected from the group consisting of 3-methyl-2,4-nonanedione, trans-4,5-epoxy-2(E)-decenal, (E)-6-nonenal, (Z)-6-nonenal, (Z)-6-octenal and (E)-2-nonenal, and in which the ratio by mass between (E)-6-octenal and the flavoring is in the range of (E)-6-octenal/3-methyl-2,4-nonanedione=0.01 to 10, (E)-6-octenal/(E)-6-nonenal=0.01 to 10, (E)-6-octenal/(Z)-6-nonenal=0.01 to 10, (E)-6-octenal/(Z)-6-octenal=0.01 to 10, (E)-6-octenal/(E)-2-nonenal=0.01 to 10, or (E)-6-octenal/trans-4,5-epoxy-2(E)-decenal=0.01 to 100.

17. A method for the manufacture of an edible fat or oil product having hydrogenated oil flavor which method comprises adding to an edible fat or oil product (E)-6-octenal in an amount effective to impart hydrogenated oil flavor to the same.

18. The method of 17 which further comprises adding one or more flavorings which are selected from the group consisting of 3-methyl-2,4-nonanedione, trans-4,5-epoxy-2(E)-decenal, (E)-6-nonenal, (Z)-6-nonenal, (Z)-6-octenal and (E)-2-nonenal.

19. The method of claim 17 by which an edible fat or oil product is made to contain (E)-6-octenal at a concentration in the range of 10 ppt to 10 ppb by mass.

20. The method of claim 17 in which the edible fat or oil product contains less than 50% by mass of hydrogenated oil on the basis of the total mass of fat or oil which is contained in the edible fat or oil product.

21. The method of claim 17 which further comprises adding one or more flavorings selected from the group consisting of 3-methyl-2,4-nonanedione, trans-4,5-epoxy-2(E)-decenal, (E)-6-nonenal, (Z)-6-nonenal, (Z)-6-octenal and (E)-2-nonenal, and in which the ratio by mass between (E)-6-octenal and the flavoring is in the range of (E)-6-octenal/3-methyl-2,4-nonanedione=0.01 to 10, (E)-6-octenal/(E)-6-nonenal=0.01 to 10, (E)-6-octenal/(Z)-6-nonenal=0.01 to 10, (E)-6-octenal/(Z)-6-octenal=0.01 to 10, (E)-6-octenal/(E)-2-nonenal=0.01 to 10, or (E)-6-octenal/trans-4,5-epoxy-2(E)-decenal=0.01 to 100.

22. An edible fat or oil product which has been manufactured by the method of claim 17.
